(19) United States
(12) Patent Application Publication
(10) Pub. No.: US 2026/0243131 A1
(43) Pub. Date: Aug. 20, 2026

(54) LADDER EXTENSION ASSEMBLY

(71) Applicant: Pure Safety Group, Inc., Pasadena, TX (US)

(72) Inventors: Andres Rubalcava, Houston, TX (US); Judd J. Perner, Missouri City, TX (US)

(73) Assignee: Pure Safety Group, Inc., Pasadena, TX (US)

(21) Appl. No.: 19/537,749

(22) Filed: Feb. 12, 2026

Related U.S. Application Data
(60) Provisional application No. 63/758,462, filed on Feb. 14, 2025.

(51) Int. Cl. E06C 1/18; E06C 1/12; E06C 7/18; E06C 7/44; E06C 7/50

(52) U.S. Cl. CPC E06C 1/18; E06C 1/12; E06C 7/182; E06C 7/44; E06C 7/50

(57) ABSTRACT

A ladder extension assembly comprises at least one of an adjustable length ladder extension assembly and a convertible lifeline anchor assembly.

### CROSS-REFERENCE TO RELATED APPLICATIONS

This application claims the benefit of U.S. Provisional Patent Application Serial No. 63/758,462, filed Feb. 14, 2025, which is incorporated herein by reference in its entirety.

### BACKGROUND

Fall protection equipment is commonly used to reduce a likelihood of a fall and/or serious injury associated with a fall, particularly by users who perform tasks at heights or are at risk of falling. Generally, lifelines or lanyards typically interconnect anchorage structures and safety harnesses donned by users. The lifelines or lanyards allow the users to move and perform tasks while being connected to the anchorage structures. Should a user fall, the fall protection equipment limits the distance the user falls.

A user climbing up and down a vertical structure, such as a ladder or a tower, typically utilizes a vertical fall arrest system (e.g., a ladder safety system) as an anchorage structure. An example vertical fall arrest system includes a ladder extension or a ladder anchor assembly to which a lifeline is connected proximate the top of the ladder. Should a fall occur, the lifeline limits the distance the user falls. An example lifeline is a self-retracting lifeline.

A ladder could be used below a hatch that remains closed during nonuse. During use, the hatch is opened and a ladder extension is commonly used to provide an anchor point above the ladder and the hatch. Positioning the ladder extension above the hatch can be tedious and time consuming.

A distance an anchor point extends from its base can be useful to ensure adequate protection such as fall clearance to avoid any swing fall hazards. Swapping anchor points can be tedious and time consuming.

For the reasons stated above and for other reasons stated below, which will become apparent to those skilled in the art upon reading and understanding the present specification, there is a need in the art for a ladder extension assembly including at least one of an adjustable length ladder extension and a convertible lifeline anchor assembly, which could be part of the same assembly or used individually with separate assemblies.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a ladder extension assembly comprises a mounting portion, an extension portion, and a locking mechanism. The mounting portion includes a connecting portion, which has a rung connector, and an adjusting portion. The extension portion is configured and arranged to be at least partially positioned within and selectively slidable relative to the mounting portion. The locking mechanism is operatively connected to the extension portion and is configured and arranged to selectively engage the mounting portion thereby adjusting a length of the extension portion extending outward from the mounting portion.

In one embodiment, a convertible lifeline anchor assembly comprises an elongate member, a first plate, a second plate, and a securing fastener. The elongate member has a first bore, a second bore, and a third bore proximate a distal end. The first plate and the second plate are positioned on opposing sides of the elongate member. The first and second plates each have a first aperture, a second aperture, and a third aperture. The first and second plates form at least a first anchor and a second anchor. The securing fastener extends through the second apertures in the first and second plates and the second bore of the elongate member thereby pivotally connecting the first and second plates to the elongate member. The first and second plates are configured and arranged to pivot about the securing fastener to move between a first position and a second position. The first apertures align with the first bore in the first position to provide access to the first anchor, and the third apertures align with the third bore in the second position to provide access to the second anchor.

In one embodiment, a ladder extension assembly comprises at least one of an adjustable length ladder extension assembly and a convertible lifeline anchor assembly. The adjustable length ladder extension assembly comprises a mounting portion, an extension portion, and a locking mechanism. The mounting portion includes a connecting portion, which has a rung connector, and an adjusting portion. The extension portion is configured and arranged to be at least partially positioned within and selectively slidable relative to the mounting portion. The locking mechanism is operatively connected to the extension portion and is configured and arranged to selectively engage the mounting portion thereby adjusting a length of the extension portion extending outward from the mounting portion. The convertible lifeline anchor assembly comprises an elongate member, a first plate, a second plate, and a securing fastener. The elongate member has a first bore, a second bore, and a third bore proximate a distal end. The first plate and the second plate are positioned on opposing sides of the elongate member. The first and second plates each have a first aperture, a second aperture, and a third aperture. The first and second plates form at least a first anchor and a second anchor. The securing fastener extends through the second apertures in the first and second plates and the second bore of the elongate member thereby pivotally connecting the first and second plates to the elongate member. The first and second plates are configured and arranged to pivot about the securing fastener to move between a first position and a second position. The first apertures align with the first bore in the first position to provide access to the first anchor, and the third apertures align with the third bore in the second position to provide access to the second anchor.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a front perspective view of an embodiment ladder extension assembly, including an adjustable length ladder extension assembly and an optional convertible lifeline anchor assembly, with the adjustable length ladder extension assembly in a retracted position, constructed in accordance with the principles of the present invention;

FIG. 2 is a partially exploded front perspective view of the convertible lifeline anchor assembly of the ladder extension assembly shown in FIG. 1;

FIG. 3 is a front perspective view of the convertible lifeline anchor assembly shown in FIG. 2 in a first position;

FIG. 4 is a front perspective view of the convertible lifeline anchor assembly shown in FIG. 2 in a second position;

FIG. 5 is a partially exploded front perspective view of a locking mechanism of the adjustable length ladder extension assembly of the ladder extension assembly shown in FIG. 1;

FIG. 6 is a front view of the locking mechanism of the adjustable length ladder extension assembly shown in FIG. 5;

FIG. 7 is a cross section view of the locking mechanism taken along the lines 7-7 in FIG. 6 in an engaged, locked position;

FIG. 8 is a cross section view of the locking mechanism taken along the lines 8-8 in FIG. 6 in a disengaged, unlocked position;

FIG. 9 is a front view of the ladder extension assembly shown in FIG. 1 with the adjustable length ladder extension assembly in an extended position; and

FIG. 10 is a rear view of the ladder extension assembly shown in FIG. 1 with the adjustable length ladder extension assembly in an extended position.

### DETAILED DESCRIPTION

In the following detailed description, reference is made to the accompanying drawings, which form a part hereof, and in which is shown by way of illustration embodiments in which the disclosure may be practiced. In this regard, directional terminology, such as "top," "bottom," "front," "back," "leading," "trailing," etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a ladder extension assembly with at least one of an adjustable length ladder extension assembly and a convertible lifeline anchor assembly. The adjustable length ladder extension assembly provides an extension portion that is easily adjusted in length to vary the distance it extends upwardly from a mounting portion without the need for tools. The convertible lifeline anchor assembly provides more than one anchor point option, each option extending a different distance from the base. Although shown and described as being operatively connected to a ladder extension assembly, the convertible lifeline anchor assembly could be used with other types of anchor devices.

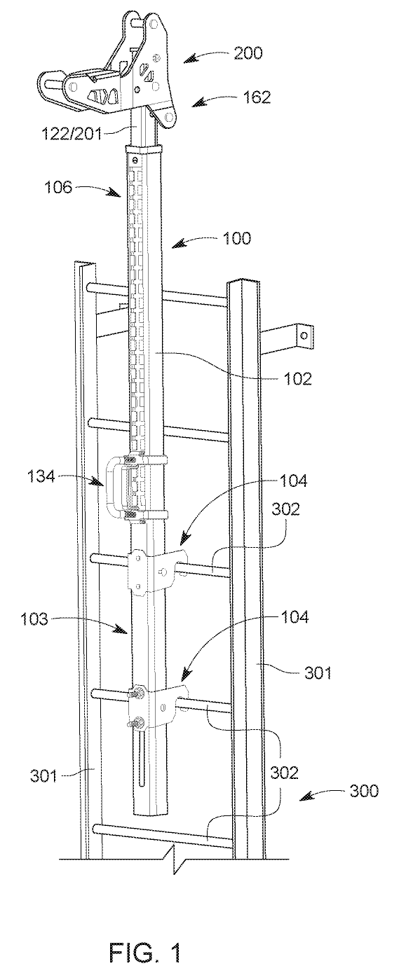

In an example, illustrated in FIG. 1, a ladder extension assembly includes an adjustable length ladder extension assembly 100 with an optional convertible lifeline anchor assembly 200. The ladder extension assembly 100 is operatively connected to a ladder 300 including side rails 301 interconnected with rungs 302. The ladder extension assembly 100 includes a mounting portion 102 and an adjusting portion 106. The mounting portion 102 includes a connecting portion 103 with rung connectors 104 configured and arranged to selectively engage rungs 302 of the ladder 300. Any suitable rung connectors can be used. The adjusting portion 106 preferably extends upward from the mounting portion 102 and includes a front face 107, a first side 112, a second side 114, and a rear face 116. The front face 107 includes a front channel 108, which preferably includes a vertical slot 109 and a plurality of lateral indexing slots 110 intersecting the vertical slot 109. The rear face 116 includes a rear channel 117.

An extension portion 122 is configured and arranged to be at least partially positioned within and selectively slidable relative to the mounting portion 102. In an example, the mounting portion 102 can be an outer tube and the extension portion 122 can be an inner tube, preferably square tubes. A lower portion 123 of the extension portion 122 includes a first bore 124 and a second bore 125, aligned with the front and rear channels 108 and 117 when positioned within the mounting portion 102, for connection to a connecting handle 150 of a locking mechanism 134.

The locking mechanism 134 includes a base 135, which includes a locking handle 136 to which a first stabilizer 138 is operatively connected to a first end and a second stabilizer 144 is operatively connected to a second end. The first stabilizer 138 includes a top 139 with an aperture 140, side stabilizers 141 extending from opposing sides of the top 139, and a first engaging member 142 extending between the side stabilizers 141. The second stabilizer 144 includes a top 145 with an aperture 146, side stabilizers 147 extending from opposing sides of the top 145, and a second engaging member 148 extending between the side stabilizers 147.

A connecting handle 150 includes a first leg 151 with a first end 152 and a second leg 153 with a second end 154 extending outward from opposing ends of the connecting handle 150. A first spring 159 is positioned about the first leg 151 proximate the connecting handle 150, and a second spring 160 is positioned about the second leg 153 proximate the connecting handle 150. The first and second legs 151 and 153 are then inserted through the apertures 140 and 146 of the base 135, through the vertical slot 109, through the bores 124 and 125, and through the rear channel 117. The first and second ends 152 and 154 are configured and arranged to extend through first and second apertures 157 and 158 of a connecting plate 156 positioned proximate the rear channel 117. Preferably, the side stabilizers 141 and 147 are positioned proximate the sides 112 and 114 of the mounting portion 102 to provide stability for the locking mechanism 134.

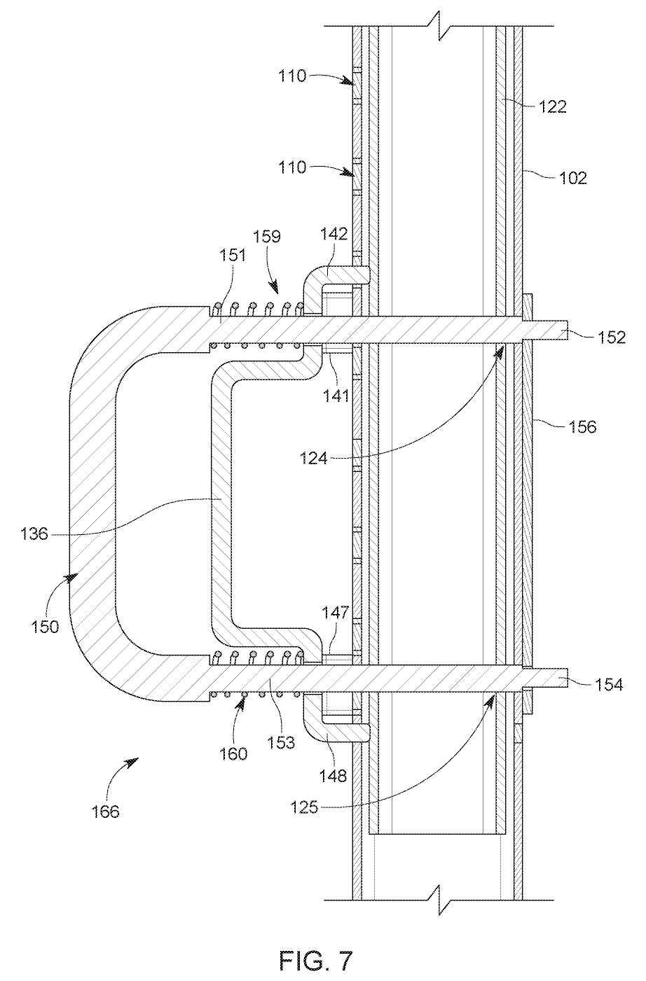

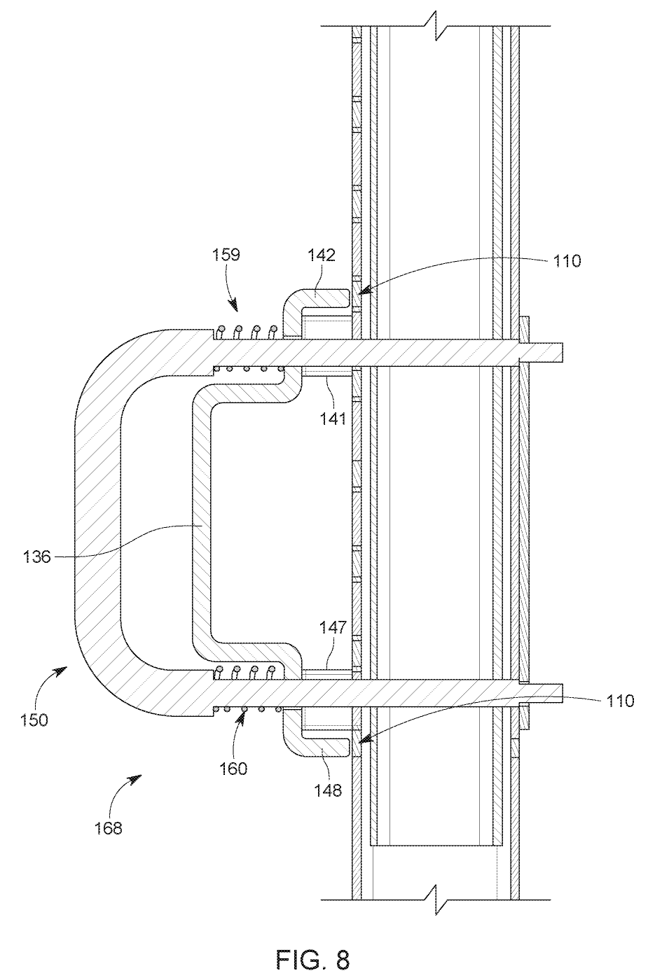

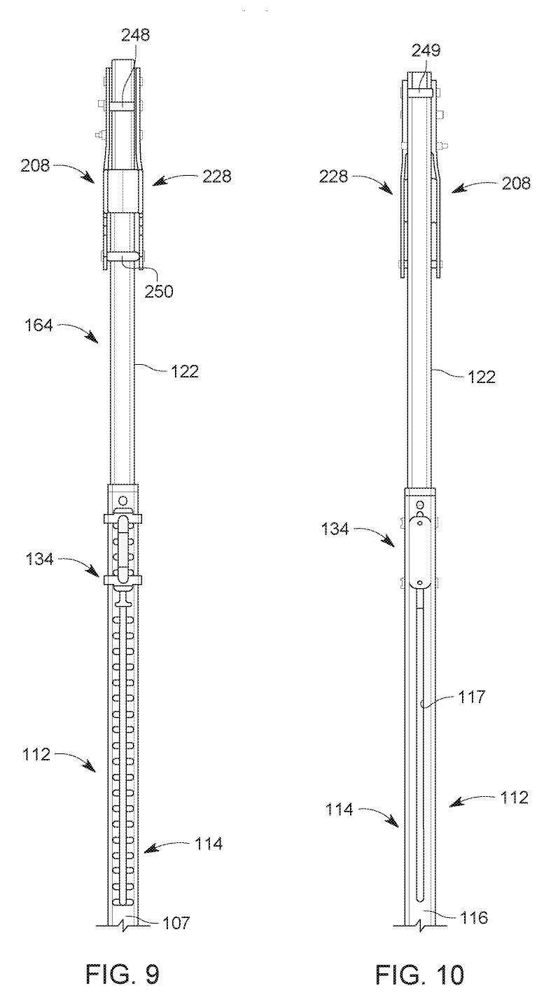

The locking mechanism 134 is biased by a biasing member (e.g., springs 159 and 160 in this example) in an engaged, locked position 166 as illustrated in FIG. 7. The locking handle 136 is moved toward the connecting handle 150, overcoming the force of the springs 159 and 160 and moving the engaging members 142 and 148 out of the respective lateral indexing slots 110, to move the locking mechanism 134 into a disengaged, unlocked position 168 as illustrated in FIG. 8. When positioned in the disengaged, unlocked position 168, the extension portion 122 can be moved relative to the mounting portion 102 by sliding the legs 151 and 153 through the front and rear channels 108 and 117. The extension portion 122 can be positioned in a retracted position 162 as illustrated in FIG. 1, an extended position 164 as illustrated in FIG. 9, or any desired position therebetween. The locking handle 136 is released and the springs 159 and 160 bias the base 135 away from the connecting handle 150 thereby positioning the engaging members 142 and 148 within respective lateral indexing slots 110 at the desired position. In some examples, there is approximately 1.0 to 1.5 inches between the lateral indexing slots 110.

A length of the extension portion 122 extending outward from the mounting portion 102 is variable because it is selectively adjustable. Because there is a built-in handle, no additional tools are needed to make the length adjustment, which makes it easy for multiple users to easily adjust the length to their preferences. In some applications, a hatch is located proximate the top of the ladder and the extension portion 122 must be positioned in the retracted position 162 to close the hatch.

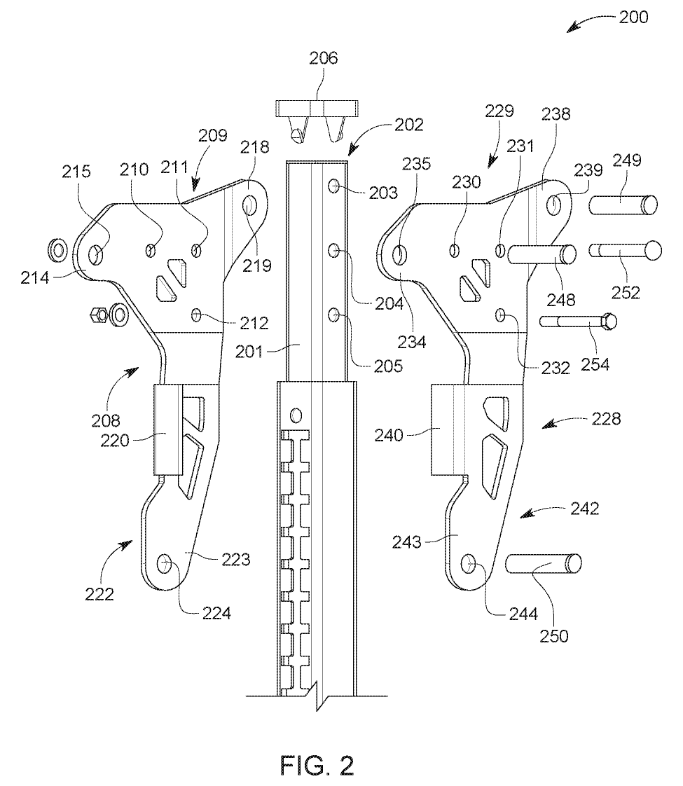

The convertible lifeline anchor assembly 200, shown in FIGS. 2-4, includes an elongate member 201, which can also be extension portion 122 of the adjustable length ladder extension assembly 100 in an embodiment, having a distal end 202 with a first bore 203, a second bore 204, and a third bore 205. An optional end cap 206 can be positioned on the distal end 202. First and second plates 208 and 228 are positioned on opposing sides of the elongate member 201 and are operatively connected thereto with at least a securing fastener 252 extending through the second bore 204 and the first and second plate 208 and 228 as described in more detail below.

The first plate 208 includes a base 209 with a first aperture 210, a second aperture 211, and third aperture 212. Proximate the first aperture 210, a first side extension 214 extends outward from the base 209, and the first side extension 214 includes an aperture 215. Proximate the second aperture 211, a second side extension 218 extends outward from the base 209, and the second side extension 218 includes an aperture 219. Proximate the third aperture 212, a third side extension 222 extends outward from the base 209. A plate 220 extends outward generally perpendicularly from an intermediate portion of the third side extension 222. A distal end 223 of the third side extension 222 includes an aperture 224. The first plate 208 can include at least one cutout to reduce its weight.

Similar to the first plate 208, the second plate 228 includes a base 229 with a first aperture 230, a second aperture 231, and third aperture 232. Proximate the first aperture 230, a first side extension 234 extends outward from the base 229, and the first side extension 234 includes an aperture 235. Proximate the second aperture 231, a second side extension 238 extends outward from the base 229, and the second side extension 238 includes an aperture 239. Proximate the third aperture 232, a third side extension 242 extends outward from the base 229. A plate 240 extends outward generally perpendicularly from an intermediate portion of the third side extension 242. A distal end 243 of the third side extension 242 includes an aperture 244. The second plate 228 can include at least one cutout to reduce its weight.

To connect the first and second plates 208 and 228, a first side extension connector 248 interconnects the first side extensions 214 and 234, a second side extension connector 249 interconnects the second side extensions 218 and 238, and a third side extension connector 250 interconnects the bottom extensions 223 and 243. Preferably, the connectors include distal ends that are deformed during assembly to secure them to the plates, and intermediate portions of the connectors provide anchors to which carabiners or other connecting members can be connected.

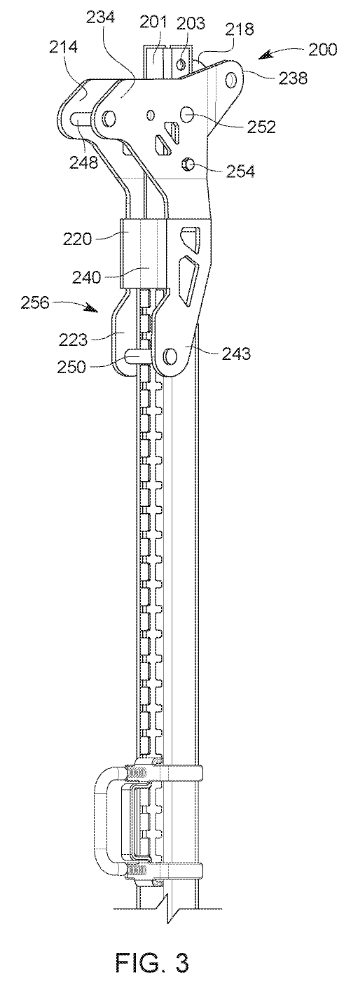

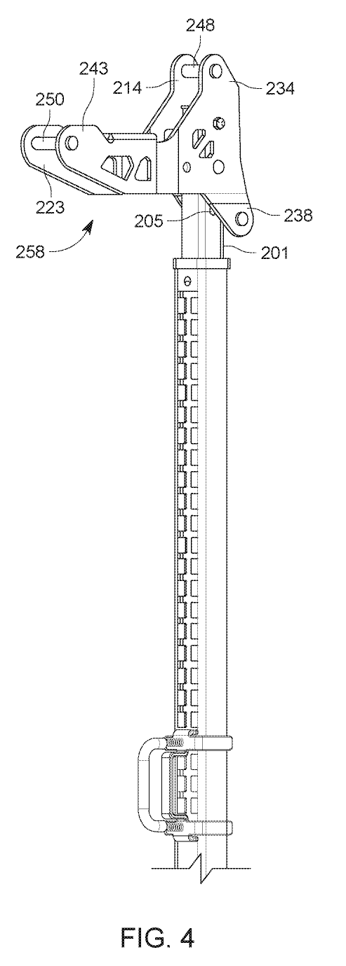

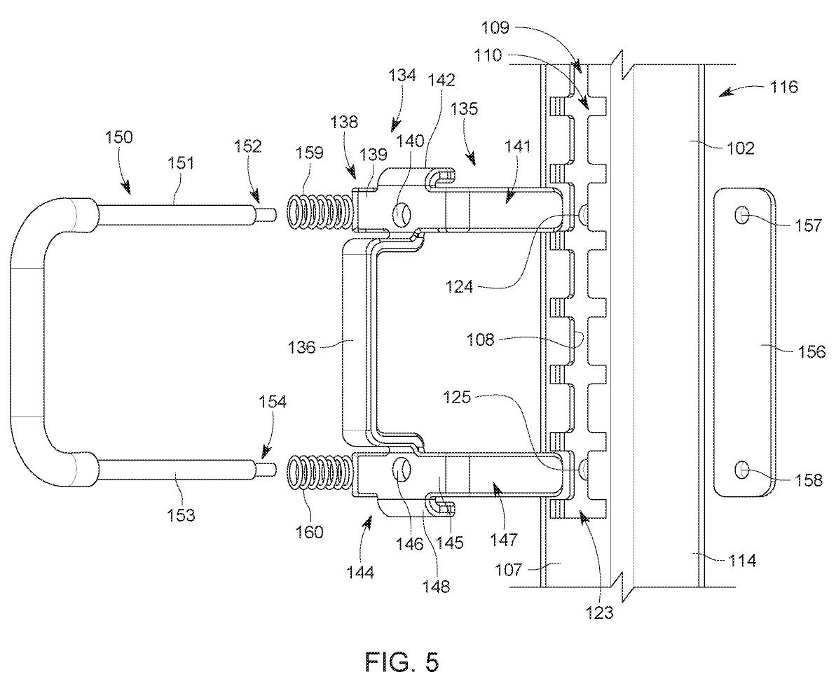

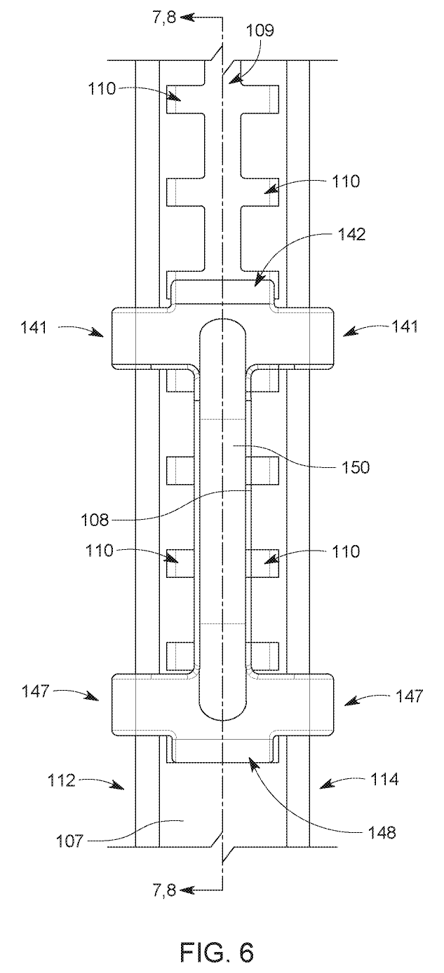

To connect the first and second plates 208 and 228 to the elongate member 201, the securing fastener 252 extends through the elongate member's second bore 204 and the plates' apertures 211 and 231 to pivotally connect the first and second plates 208 and 228 to the elongate member 201 when a removable fastener 254 is not used to secure the first and second plates 208 and 228 in a desired position. The removeable fastener 254 extends through the elongate member's third bore 205 and the plates' apertures 212 and 232 to secure the first and second plates 208 and 228 in a first position 256. As shown in FIG. 3, the first position 256 allows connection to the first anchor (connector 248) and the second anchor (connector 249). The removeable fastener 254 extends through the elongate member's first bore 203 and the plates' apertures 210 and 230 to secure the first and second plates 208 and 228 in a second position 258. As shown in FIG. 4, the second position 258 allows connection to the third anchor (connector 250).

In some examples, the first anchor provides a 5.0 inch anchor offset. In some examples, the second anchor provides a 2.0 inch anchor offset. In some examples, the third anchor provides a 12.0 inch anchor offset. It is recognized that other suitable offsets can be used.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A ladder extension assembly, comprising:
a mounting portion including a connecting portion and an adjusting portion, the connecting portion having a rung connector;
an extension portion configured and arranged to be at least partially positioned within and selectively slidable relative to the mounting portion; and
a locking mechanism operatively connected to the extension portion and configured and arranged to selectively engage the mounting portion thereby adjusting a length of the extension portion extending outward from the mounting portion.

2. The ladder extension assembly of claim 1, wherein the adjusting portion includes a plurality of indexing slots, the locking mechanism configured and arranged to be selectively positioned within at least one of the plurality of indexing slots.

3. The ladder extension assembly of claim 2, wherein the locking mechanism comprises a spring biased engaging member configured and arranged to selectively engage the mounting portion by extending into the at least one of the plurality of indexing slots.

4. The ladder extension assembly of claim 2, further comprising a vertical slot intersecting the plurality of indexing slots, the locking mechanism comprising a connecting handle with a leg extending through the vertical slot and operatively connected to the extension portion and selectively slidable within the vertical slot to move the extension portion relative to the mounting portion.

5. The ladder extension assembly of claim 4, further comprising a locking handle operatively connected to the connecting handle, wherein the locking mechanism comprises a spring biased engaging member configured and arranged to selectively engage the mounting portion by extending into the at least one of the plurality of indexing slots.

6. The ladder extension assembly of claim 5, wherein the locking handle is biased in a locked position to engage the mounting portion and is positioned in an unlocked position to disengage the mounting portion.

7. A convertible lifeline anchor assembly, comprising:
an elongate member having a first bore, a second bore, and a third bore proximate a distal end;
a first plate and a second plate positioned on opposing sides of the elongate member, the first and second plates each having a first aperture, a second aperture, and a third aperture, the first and second plates forming at least a first anchor and a second anchor;
a securing fastener extending through the second apertures in the first and second plates and the second bore of the elongate member thereby pivotally connecting the first and second plates to the elongate member, the first and second plates configured and arranged to pivot about the securing fastener to move between a first position and a second position;
wherein the first apertures align with the first bore in the first position to provide access to the first anchor; and
wherein the third apertures align with the third bore in the second position to provide access to the second anchor.

8. The convertible lifeline anchor assembly of claim 7, further comprising:
a first extension connector interconnecting the first and second plates to form the first anchor; and
a second extension connector interconnecting the first and second plates to form the second anchor.

9. The convertible lifeline anchor assembly of claim 7, wherein the first and second plates form a third anchor extending outward from an opposing side from the first anchor, the first position providing access to the first anchor and the third anchor, the second position providing access to the second anchor.

10. The convertible lifeline anchor assembly of claim 9, further comprising a third extension connector interconnecting the first and second plates to form the third anchor.

11. The convertible lifeline anchor assembly of claim 7, wherein the second anchor acts as a stop in the first position and the first anchor acts as a stop in the second position.

12. The convertible lifeline anchor assembly of claim 7, further comprising a removable fastener configured and arranged to extend through the first apertures and the first bore in the first position and configured and arranged to extend through the third apertures and the third bore in the second position.

13. The convertible lifeline anchor assembly of claim 7, wherein the first anchor provides a 12.0 inch anchor offset relative to the elongate member in the first position and the second anchor provides a 2.0 inch anchor offset relative to the elongate member in the second position.

14. The convertible lifeline anchor assembly of claim 9, wherein the first anchor provides a 12.0 inch anchor offset relative to the elongate member and the third anchor provides a 5.0 inch anchor offset relative to the elongate member in the first position, and the second anchor provides a 2.0 inch anchor offset relative to the elongate member.

15. A ladder extension assembly, comprising:
at least one of an adjustable length ladder extension assembly and a convertible lifeline anchor assembly;
the adjustable length ladder extension assembly comprising:
a mounting portion including a connecting portion and an adjusting portion, the connecting portion having a rung connector;
an extension portion configured and arranged to be at least partially positioned within and selectively slidable relative to the mounting portion; and
a locking mechanism operatively connected to the extension portion and configured and arranged to selectively engage the mounting portion thereby adjusting a length of the extension portion extending outward from the mounting portion.
the convertible lifeline anchor assembly comprising:
an elongate member having a first bore, a second bore, and a third bore proximate a distal end;
a first plate and a second plate positioned on opposing sides of the elongate member, the first and second plates each having a first aperture, a second aperture, and a third aperture, the first and second plates forming at least a first anchor and a second anchor;
a securing fastener extending through the second apertures in the first and second plates and the second bore of the elongate member thereby pivotally connecting the first and second plates to the elongate member, the first and second plates configured and arranged to pivot about the securing fastener to move between a first position and a second position;
wherein the first apertures align with the first bore in the first position to provide access to the first anchor; and
wherein the third apertures align with the third bore in the second position to provide access to the second anchor.

16. The ladder extension assembly of claim 15, wherein the adjusting portion includes a plurality of indexing slots, the locking mechanism configured and arranged to be selectively positioned within at least one of the plurality of indexing slots, and wherein the locking mechanism comprises a spring biased engaging member configured and arranged to selectively engage the mounting portion by extending into the at least one of the plurality of indexing slots.

17. The ladder extension assembly of claim 16, further comprising:
a vertical slot intersecting the plurality of indexing slots, the locking mechanism comprising a connecting handle with a leg extending through the vertical slot and operatively connected to the extension portion and selectively slidable within the vertical slot to move the extension portion relative to the mounting portion; and
a locking handle operatively connected to the connecting handle, wherein the locking mechanism comprises a spring biased engaging member configured and arranged to selectively engage the mounting portion by extending into the at least one of the plurality of indexing slots.

18. The ladder extension assembly of claim 15, further comprising:
a first extension connector interconnecting the first and second plates to form the first anchor; and
a second extension connector interconnecting the first and second plates to form the second anchor.

19. The ladder extension assembly of claim 15, wherein the first and second plates form a third anchor extending outward from an opposing side from the first anchor, the first position providing access to the first anchor and the third anchor, the second position providing access to the second anchor.

20. The ladder extension assembly of claim 19, further comprising a third extension connector interconnecting the first and second plates to form the third anchor.
